(19) United States
(12) Patent Application Publication
(10) Pub. No.: US 2008/0237150 A1
(43) Pub. Date: Oct. 2, 2008

(54) Sewage Sludge Treatment Method and System

(76) Inventors: Alain Chekroun, Hauterive (FR); Ammar Bensakhria, Thourotte (FR); Gerard Antonini, Paris (FR)

Correspondence Address: YOUNG & THOMPSON, 209 Madison Street, Suite 500, ALEXANDRIA, VA, 22314, US

(21) Appl. No.: 10/592,705

(22) PCT Filed: Mar. 17, 2005
(86) PCT No.: PCT/FR05/00649

§ 371 Date: Sep. 13, 2006

(30) Foreign Application Priority Data
Mar. 17, 2004 (FR) 0402758

(51) Int. Cl. C02F 11/14

(52) U.S. Cl. 210/770; 210/778

(57) ABSTRACT

A method for the treatment of sewage sludge, i.e. sludge originating from wastewater treatment plants, includes a step involving solid/liquid separation by filtration. The method includes a step prior to the filtration step, involving the addition of two types of solid loads, each load type including particles having a homogenous average particle size which is different from that of the particles forming the other load type, in order to form an incompressible filter matrix with a high drainage function during the filtration step.

The subject of this present invention is a process for the treatment of purification sludges, that is of the sludges obtained from purification of the waste water or sewage of local authorities or industries, as well as a system for treatment of the said sludges for the implementation of the said process.

The sludges obtained from purification of the waste water or sewage are liquid sludges whose dry material content varies from 1 to 10%, with their average moisture content generally being around 3%. These sludges are usually treated by solid/liquid separation techniques which are used used to remove both clarified liquid effluents and dehydrated sludges with a dry material content of at least 2.0%. In order to favour the solid/liquid separation, loading compounds such as flocculants are added to these sludges. The mixture is then dehydrated either by a natural method on a drying bed or indeed by freezing/unfreezing or by mechanical dehydration using filters.

The dehydrated sludges are then consigned to disposal or used as fertilisers in the agricultural sector, according to the composition of these sludges. However, this last disposal method is avoided nowadays due to the high content in these sludges of toxic metals and other contaminating substances. In addition, a European Directive dated 26 Apr. 1999 recommends avoiding the automatic consignment to disposal of these sludges, since they do not constitute a final waste material. The main remaining methods of reusing these sludges are therefore those involving their elimination by incineration or consignment to disposal of their dry materials.

German patent DE 3.922.928 thus proposes a purification sludge dehydration process that consists of mixing sludges of industrial or urban origin with purification sludges containing fibrous particles, coming in particular from the paper-making or textile industries. Synthetic or organic flocculants are then added to the mixture, then followed by filtration of the preceding mixture under pressure or under vacuum. The resulting filtration cakes have a dryness factor of more than 40%, making a good fuel and producing little ash.

This process, which provides a solution to the problem of recycling of these purification sludges by incineration, has a certain number of drawbacks however. In the first place, the moisture content of the cake remains high and its combustion is therefore not optimal from the energy viewpoint. Then, it necessitates being able create sludges containing fibrous particles of paper or textile origin, which involves the-proximity of such industries.

One of the objectives of this present invention is therefore to get around these drawbacks by proposing a solution that is simple, rapid, effective and economically interesting for the treatment of purification sludges, with a view to their elimination by consignment to disposal or by incineration.

In this regard, a process is proposed for the treatment of purification sludges, which includes a stage of separation by filtration that is remarkable in that the said process includes, prior to the separation stage, a stage for the addition of two types of solid loading, each type of loading being composed of particles with a homogeneous average grain size, as distinct from that of the particles constituting the other type of loading, in order to form an incompressible filtration matrix with a high draining power, and to obtain a filtration cake with an optimal dryness factor.

It can easily be seen that by thus creating an incompressible filtration matrix with a high draining power, it will be possible, during the filtration stage, to optimise the solid/liquid separation, in particular by avoiding clogging of the filter by the particles of dry material from the sludges which will be trapped by this incompressible matrix. As will be described in detail later, this stage is advantageously used to obtain dehydration results of greater than 90% and filtration cakes with a dryness factor of at least 60% and even of more than 80 with optimised parameters.

Other advantages and characteristics will emerge more clearly from the following description of the stages of the process according to the invention, as well as of the system of implementation of the said process, with reference to the appended drawing in which:

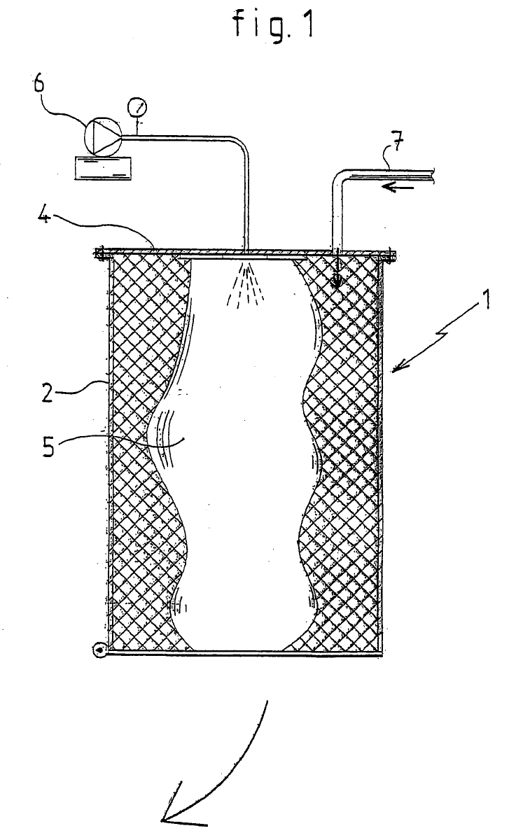

FIG. 1 is a schematic view of the filtration device used.

The sludges used for development of the process according to the invention are sludges obtained from an urban waste-water purification plant with an initial dryness factor of 2%.

These sludges are subjected to the treatment process of the invention, which includes three main stages, namely a first stage for the addition of solid loading, followed by a stage for the addition of flocculants, and finally a stage of filtration under pressure.

According to an essential characteristic of the process of the invention, the sludges obtained from the purification treatment are collected in a tank and mixed with two types of solid loading compounds. These solid loading compounds are composed of particles with a homogeneous average grain size, as distinct from that of the particles of the other loading type. The homogeneity of the grain-size distribution of the particles of the loading material used is essential to the achievement of a good solid/liquid separation during the filtration process. This stage, for the addition of solid loading to the sludges, is executed under a strong stirring action in order to ensure good dispersion of the solids. The first type of solid loading is described as the coarse fraction, and is composed of solid particles with an average grain size greater than that of the solid particles forming the second solid loading type, described as the fine fraction. The coarse fraction has as its main function to form an incompressible porous filtration matrix within the filtration cake, during the filtration stage.

The particles that can be used to form this coarse fraction can include calcium carbonate with an average diameter of more than 300 micrometres for example, or sand with an average diameter of between 190 micrometres and 700 micrometres for example.

The function of the other loading type, forming the fine fraction, apart from contributing to the constitution of the filtration matrix, is to adsorb the particles of dry material in suspension in the sludge.

This fine fraction can be composed of fine calcium carbonate for example, with an average diameter close to 20 micrometres, or of fine sand or indeed of sawdust whose average diameter is of the order of 130 micrometres.

It can easily be seen that other types of particle can be employed, the only condition being that the fine loading particles do not clog the pores of the filtration matrix.

Preferably, the solid loading will be composed of materials that are readily available and inexpensive. In addition, depending on the final destination of the dehydrated sludges, the nature of the loading materials will be chosen for best advantage.

Thus, with a view to elimination by incineration, care will be taken to improve their calorific power by introducing highly combustible particles, of the sawdust type for example.

In the case where consignment to disposal is chosen, it is preferable to favour loading materials which can easily be separated from the dry material of the sludges by breakdown of the filtration cake, in order to reduce as much as possible the quantities consigned to disposal. To this end, it is possible to use sand for the fine and coarse fractions, with recycling of the latter.

Different combinations of fine and coarse fractions have been tested, and optimal formulations for sludge with a dryness factor of 2% and a filtration stage conducted under a pressure of 60 bars are summarised in table 1 below.

| | | Dehydration | Dry material |
|---|---|---|---|
| | Mixture composition | yield | content of cake |
| Formulation I | 1000 g of sludge with dryness factor of 2% | 94.70% | 86.03% |
| | 50 g of fine calcium carbonate (d50 = 16.4 μm) | | |
| | 250 g of coarse calcium carbonate (d50 = 376.4 μm) | | |
| Formulation II | 1000 g of sludge with dryness factor of 2% | 95.20% | 80.60% |
| | 25 g of fine calcium carbonate (d50 = 16.4 μm) | | |
| | 150 g of sand (d50 = 191 μm) | | |
| Formulation III | 1000 g of sludge with dryness factor of 2% | 96.20% | 82.00% |
| | 25 g of sawdust (d50 = 129 μm) | | |
| | 125 g of sand (d50 = 191 μm) | | |
| Formulation IV | 1000 g of sludge with dryness factor of 2% | 94.90% | 80.00% |
| | 30 g of fine sand (d50 = 80 μm) | | |
| | 150 g of sand (d50 = 191 μm) | | |

The dehydration yield is defined as the ratio of the quantity of water recovered after filtration to the total quantity of water in the treated sludge before filtration.

The relative proportions of each of the fractions of solid loading are variable, of course, as a function of the initial dryness factor of the sludges, as well as of the available resources of raw materials used in the composition of these fractions.

Thus, for formulation I of the above table, the dehydration yield varies between 94.00% and 94.7% for all of the combinations between 50 and 100 g per kilo of sludge in a fine fraction of calcium carbonate, with a coarse fraction of calcium-carbonate varying between 200 and 350 g per kilo of sludge. For formulation II, combining a coarse fraction of sand and a fine fraction of calcium carbonate, a dehydration yield of more than 92% was obtained, with a proportion of calcium carbonate varying between 25 and 50 g per kilo of sludge, and a proportion of sand varying between 130 and 200 g per kilo of sludge. For formulation III, a dehydration yield of more than 95% was observed for combinations of sawdust and sand varying respectively between 10 and 25 g of sawdust per kilo of sludge and 100 to 150 g of sand per kilo of sludge. Finally, for formulation IV, combining a coarse fraction of sand and a fine fraction of sand, a dehydration yield of more than 92% was obtained with a proportion of fine sand varying between 25 and 50 g per kilogram of sludge and a proportion of coarser sand varying between 130 and 200 g per kilo of sludge.

When the sludge has been mixed with the solid loading compound, the mixture is treated in-the flocculation stage. One or more flocculants are added to the above mixture, such as those conventionally employed in this type of process, like iron salts for example. The addition of a flocculant to the sludge loaded with particles breaks down the colloidal stability of the sludges, thus freeing the water trapped in the colloidal groups and optimising the solid/liquid separation. The quantities of flocculants added vary as a function of the nature of the sludges, and in the orders of magnitude usually encountered in sludge dehydration processes.

This is followed by a solid/liquid separation stage for these reformulated sludges mixed with the solid loading compounds and the flocculants.

According to one characteristic of the invention, this solid/liquid separation consists of filtration under pressure, performed in a special device of the bladder filter-press type, with the latter being driven by the pressure of a fluid. It is during this filtration stage that a porous and non-compressible matrix will form within the filtration cake through the combination of the coarse and fine fractions of the solid loading, allowing effective draining of the water from the sludges and avoiding the clogging of the filter by the particles of dry material from the sludges. The result is thus a filtration cake with a dryness factor of more than 60%, or even 80% in optimised conditions, as demonstrated with the formulation examples given previously.

It can easily be seen that the value of the pressure applied will have an effect upon the dehydration yield. Thus, with the solid loading formulations tested, it was determined that the optimal pressure applied to the bladder is between 30 and 60 bars.

According to a last aspect of the process, the latter includes an optional stage of drying and breakdown of the filtration cakes obtained previously, with separation of the constituents. This stage allows almost total recycling (losses of less than 2% by weight) of the solid loading materials employed and thus gives rise to the consignment to disposal of “final” wastes composed essentially (more than 80%) of particles of dry material from the sludges.

As will be described in greater detail later, this stage of drying and separation of the filtration cakes is preferably based on the fluidised bed technique.

The operating parameters can be optimised without difficulty by the professional engineer, as a function of the residual moisture content of the cakes and the nature of the solid loading employed.

Thus, tests conducted on filtration cakes containing 70.6% of sand (fine and coarse fraction), 9.4% of particles of dry material from sludges, and 20% moisture content have highlighted the importance of the fluidisation speed and fluidisation air temperature. In fact, higher fluidisation speeds result in a more rapid attrition of the cakes introduced by increasing the turbulence/collision effect. In addition, it was also observed that the use of hot air favours the breakdown of the fine sludge particles and their separation from the sand particles.

With the aforementioned composition of the filtration cakes, there is thus a reduction in the sand losses of 2% to 1.13% by going from a temperature of 20° C. to 170° C. for a fluidisation speed of between 3 and 4 m/s. At the same times, the sludge particle content of the fraction recovered at the output of the cyclone rises from 81 to 91%.

Another subject of the invention is the sludge treatment system used to implement the process just described.

This sludge treatment system therefore includes a first reactor vessel for dispersion of the loading materials, to allow mixing of the purification sludges and the two solid loading fractions. Of course the treatment system can also include a storage tank for the purification sludges as well as a storage reservoir for each of the two types of solid loading. After stirring, the mixture is transferred by pump into a flocculation reactor, which is also fed with the flocculant obtained from a reactor for preparation of the latter. The mixture formed in the flocculation reactor is then transferred into the filtration device of the invention.

Referring to FIG. 1, this filtration device 1 is composed of a cylindrical metal grill 2 constituting the filter, whose bottom 3 is removable in order to allow extraction of the filtration cake once the filtration stage has ended. The second end of the cylinder 2 is closed by a lid 4 to which a sealed bladder 5 is attached, on its internal side and co-axially to the cylinder. This bladder 5 is connected to a hydraulic unit 6 allowing the injection of water under pressure into the bladder 5.

In order to dehydrate the sludges, the mixture obtained from the flocculation reactor is therefore introduced into in the filtration device 1 via a filling orifice 7 located at the top of the cylinder. Pressure is then applied to the bladder 5 which squeezes the mixture uniformly against the cylindrical inner wall of the filter and allows the removal of all the residual water not removed by gravity alone. This pressurisation stage lasts for some minutes, and one to two minutes in general. The bladder 5 is then deflated and the cake formed is recovered by removing the bottom 3 and extracting the cake by means of an appropriate tool, such as a metal rod or indeed an annular disk place against the inner face of the lid 4 of the filtration device 1 and guided by a rod which is pushed downward in the longitudinal direction of the filtration device in order to shift the filtration cake. This then provides a combustible product consisting of purification sludges which are now advantageously in the form of a hollow cylinder which will facilitate combustion.

Advantageously, the internal structure of these filtration cakes, with a large specific surface area (m²/kg) and open porosity further improves the dryness factor of the cake by simple natural drying by convection.

Thus for example, in the case of a cake obtained from the process of the invention with the parameters of formulation III above, the dryness factor rises from 82% to 87% after a 30-minute bathing in ambient air (T=20°C.). A 30-minute bathing in hot air (T=70° C.) results in a dryness factor of 91%.

The economic advantages of the process can be better appreciated by considering the overall energy yield and the lower calorific losses during combustion of the filtration cake.

However, one cannot ignore the fact that the cost of the incineration installations limits the viability of this recovery technique. For local authorities with a reduced volume of purification sludges to be treated, the method of consignment to disposal is preferable, on condition however that most of the solid loading added for the filtration process can be recycled, making the cost of treating these sludges economically bearable.

In this light, the sludge treatment system can consist of a single-stage, fluidised bed, drying/separation stage.

Preferably, a device will be chosen whose design allows reinforcement of the dynamic mixing within the bed, in order to ensure a very complete separation of the filtration cakes introduced into fluidised-bed device (broken down upstream at the level of the feeding device).

In order to satisfy this requirement, use will be made of a fluidisation device with multiple hot-air jets, generating high local turbulence, while also allowing a moderated gas-flow speed at the output (less than the speed necessary to disturb the sand).

Such a drying/separation assembly allowing continuous treatment of the filtration cakes obtained from the filter-press will include:
a feed hopper with lump-breaking device, feed screw and airlock,
a fluidised-bed separator/drier,
a fluidisation air pressuriser with variable-speed motor,
an electric air heater (air temperature of 200° C.),
a cyclone with an airlock,
a bag-type filter,
an active charcoal filter,
a variable-speed centrifugal extractor fan,
a moist-air extraction chimney,
an electrical/instrumentation installation assembly with cabinet and independent command/control system.

Of course the sludge treatment system of the invention can include several filtration devices placed in parallel and operating intermittently, allowing virtually continuous treatment of the sludges combined with solid loading and flocculants, and the feeding of an incinerator or fluidised bed drying/separator assembly.

It can also be seen easily that the professional engineer is quite capable of designing the dimensions of the treatment system as a function the quantity of purification sludges to be treated.

Finally, it goes without saying that the process for the treatment of sludges can be applied to all types of purification sludges, and that the examples of formulation of the solid loading described above are merely particular illustrations, and do not limit in any way the application of the invention.

1-15. (canceled)

16. A process for the purification of treatment sludges, that is of sludges obtained from waste-water or sewage purification installations, which includes a solid/liquid separation stage by filtration, characterised in that, prior to the filtration stage, the said process includes a stage for the addition of two types of solid loading, each loading type being composed of particles with a homogeneous average grain size, as distinct from that of the particles constituting the other loading type, in order to form an incompressible filtration matrix with a high draining power, during the filtration stage.

17. A process according to claim 16, characterised in that a first type of solid loading forms the coarse fraction of the loading, composed of solid particles with an average diameter greater than that of the solid particles forming the second type of loading materials, where this coarse fraction is intended to form the incompressible porous network of the filtration matrix.

18. A process according to claim 17, characterised in that the second type of loading forms the fine loading fraction, where this fine fraction is intended to adsorb the particles of dry material of the purification sludge.

19. A process according to claim 18, characterised in that the fine fraction and the coarse fraction are composed of particles of calcium carbonate.

20. A process according to claim 18, characterised in that the fine fraction and the coarse fraction are composed of sand particles.

21. A process according to claim 18, characterised in that the fine fraction is composed of particles of calcium carbonate and the coarse fraction is sand.

22. A process according to claim 16, characterised in that the stage for addition of the solid loading material is executed under a strong stirring action, in order to ensure good dispersion of the loading materials in the sludge.

23. A process according to claim 16, characterised in that the stage for the addition of the solid loading is followed by a flocculation stage, before proceeding to the solid/liquid separation stage.

24. A process according to claim 16, characterised in that the solid/liquid separation stage is a stage of filtration under pressure.

25. A process according to claim 24, characterised in that the filtration under pressure is conducted in a filter-press (1) that includes a cylindrical metal grill (2) forming the filter, and which is equipped with a sealed bladder (5) located along the central longitudinal axis of the cylinder, this bladder being driven by the pressure of a fluid.

26. A process according to claim 16, characterised in that the solid/liquid separation stage by filtration is followed by a stage for drying and breakdown of the filtration cakes obtained at the previous stage.

27. A process according to claim 18, characterised in that the fine fraction is composed of particles of sawdust and the coarse fraction is composed of sand.

28. A device for filtration under pressure (1), of the filter-press type, for installations for the treatment of purification sludges, characterised in that it includes a cylindrical metal grill (2) forming the filter, and a bladder (5) which is operated by a hydraulic unit, placed coaxially with the grill (2) and attached to the inner face of the lid (4) of the said grill (2).
